(19) United States
(12) Patent Application Publication
(10) Pub. No.: US 2006/0024453 A1
(43) Pub. Date: Feb. 2, 2006

(54) Elastomeric structural elements

(75) Inventors: Greg Setser, Guasti, CA (US); Larry Kuncl, Upland, CA (US); William Hansen, Santa Barbara, CA (US)

Correspondence Address: SHIMOKAJI & ASSOCIATES, P.C., 8911 RESEARCH DRIVE, IRVINE, CA, 92618, US

(73) Assignee: Crosstie Technologies, Inc., Ontario, CA (US)

(21) Appl. No.: 10/360,097

(22) Filed: Feb. 5, 2003

(51) Int. Cl. B29C 43/02

(52) U.S. Cl. 428/2; 264/104; 264/319

(57) ABSTRACT

Apparatus for and methods to manufacture elastomeric structural elements utilizing significant quantities of discarded rubber as well other materials, such as unvulcanized rubber compounds, commercial rubber binders, and thermoplastic rubber. The inventive elastomeric structural elements are well suited for use on railroads, highways, buildings, and other structural applications as replacement for traditional materials such as wood, steel, aluminum, concrete, plastics, composites, recycled pressed wood products, and combinations of various recycled materials.

### BACKGROUND OF THE INVENTION

The present invention generally relates to elastomeric structural elements and methods for fabricating such elements and, more specifically to elastomeric structural elements suitable for use on railroads, highways, buildings, and other related applications, and methods for fabricating such elements made principally of recycled rubber products.

There exists a dilemma of worldwide proportions involving the disposition of many millions of used and worn automobile, truck, airplane and other vehicular tires. Disposition of such tires has created an enormous environmental problem. The tires are generally disposed of in huge mountain-high piles, government-controlled dump sites, or in deep canyons, resulting in visual and land pollution as well as danger of fires. Tire disposal site fires are large and dense, have smoke plumes that pollute the air for hundreds of miles, and are extremely difficult to extinguish. In fact, some tire fires are not extinguished at all, but instead are allowed to burn themselves out, sometimes for periods of years. Tire fires may also cause ground water pollution by virtue of liquid and/or solid (usually in the form of oxidized dust or ash) hydrocarbons being released due to pyrolitic reactions.

Generally, discarded tires contain a rubber matrix comprising natural and/or synthetic rubber, carbon black, plastisizers, cross-linkers, anti-oxidants, anti-ozone agents and other performance improving additives plus metal and/or fiber reinforcement. Many of those components are provided to resist thermal and biological degradation, mechanical wear, ultraviolet radiation, ozone and other oxidants, as well as water and ice. The result is that discarded tires have a very long life, do not decay, and may remain in the disposal sites for very long periods of time.

Unfortunately, tires are presently being recycled on a very limited scale. Some are ground into particles useful in roadway paving. Others are used in the creation of artificial reefs to improve fishing. Many are simply disposed of in landfills, even though some states require pre-shredding to eliminate tire “jumping” (a phenomena whereby tires work their way to the surface settling on top or even “jumping” out of the earth). Also, attempts have been made to recycle at least parts of tires into structural beams, low vibration flooring, filling material for building work, mats, and even mixing with compost has been suggested.

One example is U.S. Pat. No. 6,316,509 to Degerman, which teaches a process for reuse of vulcanized rubber. The material composition comprises recycled rubber from tires and other similar sources, a thermoplastic such as polypropene, expandable microspheres, and conventional additives such as pigments. The blended materials are heated and pressurized in a mold, producing shaped bodies, such as flooring underlays providing insulation against moisture, cold and noise, fillings for sandwich-like construction projects, waste containers, and shock absorbers.

Another promising application for recycled rubber tires involves railroad crossties (including switch ties, switch tie sets, and other structural rail attachment and support structures), historically made of wood, which typically carry train-induced compressive or weight bearings loads, and maintain track alignment. However, because worldwide wood stocks have been gravely depleted, the railroad industry has for some time considered alternative products and materials, including crossties made of recycled tire rubber dust or crumb rubber, the latter being readily available on the open market. Present technology can economically shred and granulate tires, magnetically separate the steel, and remove various fibers, so that the recycled end product has the characteristics necessary for a host of commercial uses. The technology for reducing tires to rubber crumb is described in U.S. Pat. No. 4,726,530 to Miller, et al. and U.S. Pat. No. 5,094,905 to Murray. Both of said patents are hereby incorporated herein by this reference.

PCT application WO 01/88270 A1 to Hansen (hereafter PCT/Hansen) discloses a method to manufacture railroad crossties from recycled rubber tires. The method involves milling and extruding, at elevated temperatures, two distinctly separate types of recycled crumb rubbers (RCR) made by granulating, to a fine dust, discarded vehicle tires commonly available at waste disposal facilities. The first type of RCR is, what is called, recycled “vulcanized crumb rubber” made from automobile and truck tires, said to contain primarily vulcanized natural and synthetic rubbers and carbon black. The second type of RCR is, what is called, recycled “natural crumb rubber” made from tires classified as natural rubber or from rubber which has been, what is called, “de-vulcanized” (although the specific meaning of the term de-vulcanized is not disclosed). Tires called natural rubber tires are mostly off-the-road (OTR) tires, which are said to have less sulfur and zinc content and a lower melting point than those called vulcanized rubber tires. Natural or de-vulcanized rubbers, which are presumed to have similar features, are said to provide the adhesive qualities needed to mill and extrude the blend.

Other features of the method taught by Hansen include:
a) A mixture ratio, by weight, of 10-35% recycled natural crumb rubber to 65-90% recycled vulcanized crumb rubber, both no larger than 30 mesh (0.0232 inch). For cohesiveness and strength purposes, it is vital that both types of RCR be ground to the specified very fine mesh size.
b) The two types of RCR must be stocked separately. One of them, recycled natural crumb rubber from OTR tires, is not readily available by itself in large quantities as it is generally stocked, shredded, and recycled together with tires having vulcanized crumb rubber.
c) Individualized control and monitoring of “natural crumb rubber” and “vulcanized crumb rubber” as each have different melting points and chemical characteristics.
d) Polymers may be used as a last resort if the desired compression strength, verified by test specimen, of the product is not achieved by adding up to 35% natural crumb rubber (by weight) to the blend. The polymer in very low quantities (not to exceed 0.25% to 0.50% by total weight) may be utilized to achieve the desired adhesive consistency of the blend, but only if the natural crumb rubber content exceeds 35% of the total blend weight.
e) The blended materials (RCR and polymer, if used) are said to be heated and compressed, in a roller mill, to produce strips to be fed into an extruder.
f) Very high extrusion pressures of up to 2500 psi are applied to what is termed a heavy-duty extrusion mold or die to assure adequate flow of the blended materials (RCR and polymer, if used) around mold obstacles and corners, and to avoid internal and external material voids and loose compaction.
g) Indentations may be added on longitudinal sides of railroad cross ties to improve frictional engagement with gravel beds and to avoid slipping or sliding during positioning and alignment.

While these are very worthwhile attempts to recycle rubber tires, many more are needed if there is to be even a partial solution to the worldwide dilemma resulting from disposition of the enormous quantities of used and worn tires.

As can be seen, there is a continuing need for improved apparatus and methods for simply, efficiently, and economically fabricating elastomeric structural elements made principally of recycled rubber products.

### SUMMARY OF THE INVENTION

In one aspect of the invention, there is disclosed a method for fabricating elastomeric structural elements, comprising the steps of: blending materials comprising recycled crumb rubber and a binder; curing the blended, recycled crumb rubber and binder, without first milling, in a compression mold at elevated temperature and pressure, to form elastomeric structural elements; and, gradually cooling the cured elastomeric structural elements until ready for storing and shipping.

In another aspect of the present invention, there is disclosed a method for fabricating elastomeric structural elements, comprising the steps of: blending materials comprising recycled crumb rubber, a binder comprising uncured vulcanizable rubber compound or alternately unset thermoplastic rubber compound, and a hardener; placing materials, without first milling, in an extruder; extruding the materials onto a compression mold; removing from the compression mold cured elastomeric structural elements; and, allowing the elastomeric structural elements to cool gradually for storing and shipping.

In yet another aspect of the present invention, a method for fabricating elastomeric structural elements is disclosed. The method comprises the steps of: blending materials comprising: 40-80% by batch weight of recycled crumb rubber from any source containing a blend no larger than in the range of 9/64 to 1/20 inch (3.6 to 1.3 mm); 20 to 60% by batch weight of a binder comprising uncured vulcanizable rubber compound; and 0.1 to 2% by batch weight of a hardener; placing the materials, without first milling, in an extruder; extruding onto a compression mold the materials; compressing and heating the materials, while in the compression mold, to a pressure of 250 to 1250 psi (1724 to 8618 kPa) at a temperature of 210 to 350° F. (99 to 177° C.) for a period of 10 minutes to 8 hours; removing the cured elastomeric structural elements from the compression mold; and allowing the cured elastomeric structural elements to cool gradually for storing and shipping.

In still another aspect of the present invention, there is disclosed a method for fabricating elastomeric structural elements, comprising the steps of: blending materials comprising recycled crumb rubber and a binder; placing the materials for curing, without first milling, in a compression mold at elevated temperature and pressure; removing from the compression mold the cured elastomeric structural elements, and allowing the cured elastomeric structural elements to cool gradually for storing and shipping.

In a further aspect of the present invention, there is disclosed a method for fabricating elastomeric structural elements, comprising the steps of: blending materials comprising 90 to 97% by batch weight of recycled crumb rubber from any source having a particle size no larger than in the range of 9/64 to 1/20 inch (3.6 to 1.3 mm), and 3 to 10% by batch weight of a binder; placing the materials for curing, without first milling, in a compression mold at elevated temperature and pressure; removing from the compression mold the cured elastomeric structural elements, and allowing the cured elastomeric structural elements to cool gradually for storing and shipping.

In a yet further another aspect of the present invention, there is disclosed an elastomeric structural element, comprising: materials comprising recycled crumb rubber and a binder; wherein the materials are cured in a compression mold at elevated temperature and pressure to form cured elastomeric structural elements; wherein the cured elastomeric structural element is cooled gradually until ready for storing and shipping.

In a still further aspect of the present invention, there is disclosed an elastomeric structural element, comprising: a batch of materials comprising 40-80% by weight of recycled crumb rubber containing a blend no larger than in the range of 9/64 to 1/20 inch (3.6 to 1.3 mm), 20-60% by weight of uncured volcanizable rubber compound, and 0.1 to 2% by weight of a hardener; wherein the materials are extruded onto a compression mold; wherein the materials are cured in the compression mold at elevated temperature and pressure to form cured elastomeric structural elements; wherein the cured elastomeric structural elements are cooled gradually until ready for storing and shipping.

In yet one other aspect of the present invention, there is disclosed an elastomeric structural element, comprising: materials comprising 90 to 97% by weight of a portion of recycled crumb rubber from any source containing a blend no larger than in the range of 9/64 to 1/20 inch (3.6 to 1.3 mm), and 3 to 10% by weight of a binder; wherein the materials are blended and placed in a compression mold; wherein the batch of materials are cured in the compression mold at elevated temperature and pressure to form cured elastomeric structural elements; wherein the cured elastomeric structural elements are cooled gradually until ready for storing and shipping.

These and other features, aspects and advantages of the present invention will become better understood with reference to the following drawings, descriptions and claims.

### BRIEF DESCRIPTION OF THE DRAWINGS

FIG. 1 is a flow diagram of a general method of fabricating elastomeric structural elements according to an embodiment of the present invention;

FIG. 2 is a flow diagram of the method of FIG. 1 illustrating a specific extrusion method of fabricating elastomeric structural elements according to an embodiment of the present invention;

FIG. 3 is a flow diagram of the method of FIG. 1 illustrating a specific compression mold method of fabricating elastomeric structural elements according to embodiment of the present invention;

FIG. 4 is a perspective view of an installed railroad crosstie made according to an embodiment of the present invention;

FIG. 5 is a perspective view of a rectangular-shaped elastomeric structural element made according to an embodiment of the present invention;

FIG. 6 is a perspective view of a cylindrically-shaped elastomeric structural element made according to an embodiment of the present invention;

FIG. 7 is a perspective view of an I-beam-shaped elastomeric structural element made according to an embodiment of the present invention;

FIG. 8 is a perspective view of a channel-shaped elastomeric structural element made according to an embodiment of the present invention;

FIG. 9 is a perspective view of a strip-shaped elastomeric structural element made according to an embodiment of the present invention;

FIG. 10 is a perspective view of a tile-shaped elastomeric structural element made according to an embodiment of the present invention;

FIG. 11 is a perspective view of a mat-shaped elastomeric structural element made according to an embodiment of the present invention,

FIG. 12 is a perspective view of a bumper-shaped elastomeric structural element made according to an embodiment of the present invention;

FIG. 13 is a perspective view of a pyramid-shaped elastomeric structural element made according to an embodiment of the present invention;

FIG. 14 is a perspective view of a cone-shaped elastomeric structural element made according to an embodiment of the present invention;

FIG. 15 is a perspective view of a series of interconnected rectangular-shaped curbing members made according to an embodiment of the present invention; and

FIG. 16 shows several cross sectional view embodiments of interconnected rectangular-shaped curbing members taken along lines 16A-16A of FIG. 15.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the in invention is best defined by the appended claims.

The present invention generally provides methods to manufacture elastomeric structural elements utilizing significant quantities of discarded rubber combined with other materials, such as virgin rubber. More specifically, the inventive elastomeric structural elements are well suited for use on railroads, highways, buildings, and other related applications as replacement for traditional materials such as wood, steel, aluminum, concrete, plastics, composites, recycled pressed wood products, and combinations of various recycled materials. They can be made economically and take advantage of the plentiful supply of discarded rubber tires stockpiled at waste disposal sites throughout the world. The elastomeric material incorporates physical and mechanical properties that make it adaptable for numerous uses. Those properties include strength, resistance to corrosion, elasticity, formed-shape retention, resistance to weathering, long useful life, low noise transmissivity, electrical insulation, if desired, low weight, interchangeability with conventional materials, and capability to be recycled upon expiration of its original useful life. In a typical application, such as railroad crossties, the material also provides a markedly increased grip between the crosstie and the sub-bed (whether ballast, such as gravel, soil, pavement, concrete or other surface) to prevent undesired lateral and longitudinal crosstie movement as well as efficient functionality with traditional spikes and other methods of rail attachment.

This is unlike traditional prior materials, which generally suffer from various disadvantages, including high cost, difficult installation, and deterioration due to corrosion, organism infestation, fungicidal invasion, chemical leaching, freeze/thaw cycling, and vibration. Additionally, traditional materials also are subject to shortages, delays, excessive weight, instability, inability to abate noise, limited useful lives, as well as inability to take advantage of extensive available resources, such as recycled rubber obtained from discarded tires.

It is also unlike prior art rubber tire recycling methods, such as taught by PCT/Hansen, in at least the following specific aspects:
a) Only one type of recycled crumb rubber (RCR), obtained from any source (e.g., tires or otherwise), is needed. It is unnecessary to stock two different kinds of RCR, each one obtained from a different recycled tire source.
b) There is no need to individually control and monitor the different melting points and chemical characteristics of “natural rubber” and “vulcanized rubber”.
c) The RCR need not be ground to a fine dust (30 mesh or less), because small particles are not essential for strength or cohesiveness of the blended materials. In fact, too fine a dust would act as a contaminant to the present invention.
d) Batch specimen screening tests are not needed for strength verification and/or for adjustment of material quantities.
e) The blended materials (RCR and vulcanizable rubber compound or polyurethane based binder) do not need to be roller milled prior to being fed into an extruder or compression mold.
f) There is no need to extrude the blended materials at high pressures of up to 2500 psi in a heavy-duty mold to assure flow around obstacles and corners, and to avoid internal and external voids and loose compaction.
g) Railroad crossties made from the recycled materials according to the present invention do not need indentations on longitudinal sides to assure frictional engagement with gravel beds and to avoid slipping or sliding during positioning and alignment.
h) The recycled rubber tire product's uses are nearly unlimited and include railroads, highways, buildings, water dams and levees, marine dock products, and other related applications as replacement for traditional materials.

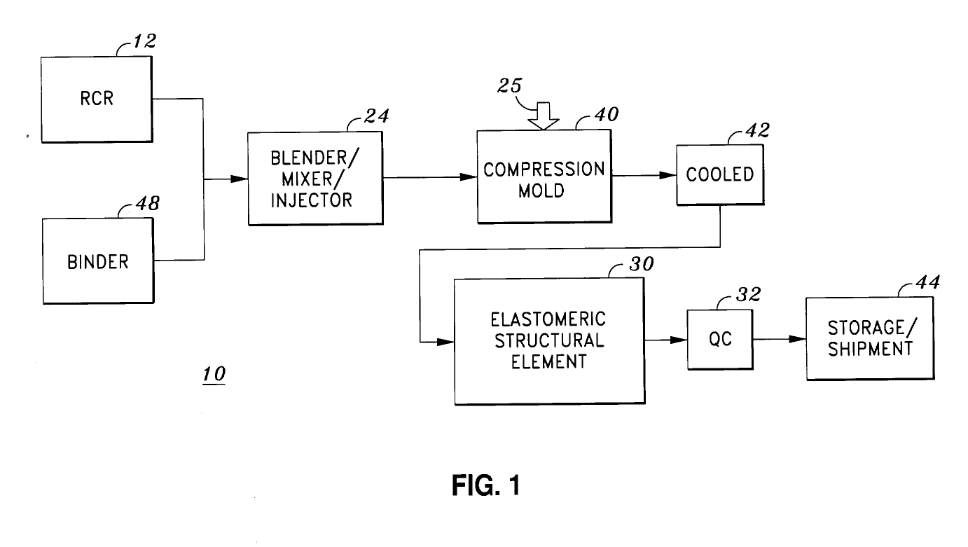

Referring to the accompanying drawings (in which like reference numerals indicate like parts throughout several views), and in particular to FIG. 1, there is shown a flow diagram of a general method 10 for fabricating elastomeric structural elements 30 according to an embodiment of the present invention. Method 10 may involve mixing a single type (as distinguished from prior art requiring two different types) of RCR 12, obtained from any source (e.g., recycled tires or recycled rubber from other sources) and a binder 48. The binder 48 may be in the form of an uncured vulcanizable rubber compound or a thermoplastic rubber-based compound (described in detail below as part of extrusion method 11), or a generally polyurethane-based commercially available rubber binder (described in detail below as part of compression mold method 46) or other suitable equivalent.

RCR 12 component may comprise any type of recycled crumb rubber, whether vulcanized, natural or de-vulcanized, synthetic, or natural, made from any source, including discarded tires regardless of manufacturer, model, age (year), batch, and extent of usage. Since recycled rubber is comprised primarily of discarded tires, the general composition may be expected to vary widely for tires from cars, trucks, heavy equipment, off-the-road vehicles, aviation, etc. Generally, however, highway vehicular tires may include 14 to 27% natural rubber, 14 to 27% synthetic rubber (both depending on whether car, truck tires, or otherwise), up to approximately 28% carbon black, 14 to 15% steel, and the balance made up of fabrics, fillers, accelerators, antiozonants, and contaminants, such as water, dust, sand, soil, biologics, and microorganisms.

Unlike prior art, it is not necessary that the RCR 12 component be comprised of two separate, distinct, and individually controlled and stocked recycled crumb rubber sources, namely, natural or de-vulcanized rubber (as indicated previously, the latter term is not defined by PCT/Hansen) obtained from OTR type tires and vulcanized crumb rubber. In fact, for the present inventive method, it may be more desirable to avoid use of natural/de-vulcanized rubber obtained from OTR type tires, as that type of recycled rubber is expensive and difficult to obtain.

As previously discussed, the technology for reducing recycled rubber from sources such as tires to rubber crumb is well known and described in U.S. Pat. Nos. 4,726,530 and 5,094,905. The process may involve the removal of electrically conductive metal (normally from steel belts or beads) to assure electrical isolation is obtained for specific applications, such as may be necessary for railroad crossties. Additionally, certain applications may also require removal of fibers, a task that may also be accomplished by vacuum as part of the rubber shredding and granulating process.

RCR 12 and binder 48 may be mixed in blender, injector, or mixer 24, and placed in compression mold 40 having the geometry and dimensions of the desired end product, as discussed below. While in compression mold 40, RCR 12 and binder 48 are formed in the shape of elastomeric structural elements 30, by application of heat/pressure step 25 at the specific values addressed below. It is not necessary, as is the case for some prior art processes, to mill the blended materials prior to curing. After being cooled 42 to ambient temperature for a period of up to 48 hours without exposure to freezing temperatures, completed elastomeric structural elements 30, may be ready for a quality assurance step 32 involving both geometric and physical measurements and tests. Acceptable elastomeric structural elements 30 may then be ready for the storage/shipment step 44 to user destinations. Method 10 may use materials, material quantities, and processes, as further discussed in the extrusion method 11 and compression method 46 embodiments addressed below.

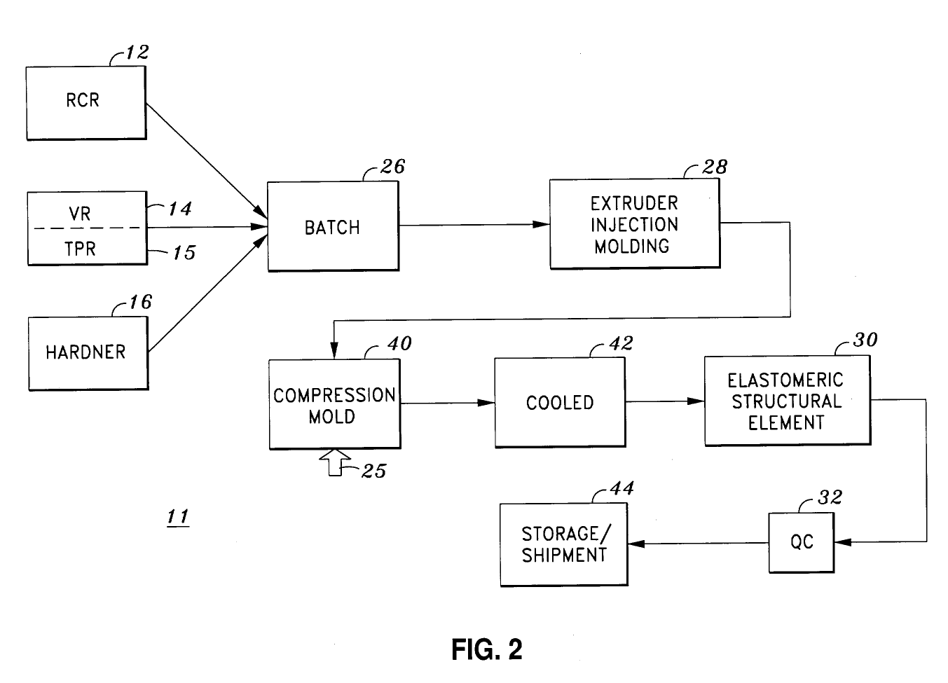

Referring now to FIG. 2, there is shown a flow diagram of an extrusion method 11 of fabricating elastomeric structural elements 30 according to an embodiment of the present invention. As further addressed below, extrusion method 11 may also include use of an injection mold 29 process. The extrusion method 11 may involve mixing the following materials to form a batch 26: RCR 12, binder VR 14 (vulcanizable rubber compound), and an additional hardener 16, to the extent necessary. In an alternate embodiment, TPR 15 (thermoplastic rubber compound) may substitute VR14. As discussed above, only one RCR 12 component, obtained from any source (recycled tires or recycled rubber from other sources), may be needed. It may also be acceptable to use crumb rubber that has been shredded and granulated cryogenically (with the rubber in a frozen state) even though that process may leave a glossy surface on the rubber particles.

RCR 12 may be granulated to a most preferred particle size of 5/64 inch (2 mm), although it may be acceptable to have a preferred particle size range of from 3/32 to 1/16 inch (2.4 to 1.6 mm) and a useful particle size range of from 9/64 to 1/20 inch (3.6 to 1.3 mm). Particle size control may be either “pure” size or “minus” size. The latter industry designation allows inclusion of limited quantities (generally less than 5%) of particles having a smaller particle size, an acceptable condition for this inventive concept. However, sizeable quantities (over 15%) of very small particles (less than 1/20 inch) may be undesirable as that may increase void content as well as increase the quantities of hardener 16 and VR 14 (or alternatively TPR 15).

Unlike prior art, the smaller particle sizes may not be vital for the cohesive properties of the finished product, since cohesiveness and strength may be provided by the binder component, as further discussed below. Use of a large RCR 12 particle size may also provide some benefits in that the larger sizes may be more economical to produce (e.g., below 1/16 inch requires very expensive additional cracker mills), may be more readily available, and may be easier to handle.

Each batch 26 may comprise RCR 12 in a most preferred amount of 75% of total batch weight, while a preferred range may be 60% to 80%, and a useful range may be 40% to 97%.

VR 14 may be defined as an uncured vulcanizable rubber compound. The VR 14 composition may be generally similar to that of a normal vehicle tire, and may include 55 to 60% NR (Natural Rubber) and/or SBR (Styrene Butadiene Rubber), 10 to 40% carbon black, 0 to 30% oils, and small percentages of fillers, accelerants, sulfur and other hardeners, and antiozonants. However, since vulcanization may not have occurred, the curing agents and the sulfur component may be in a pure form (e.g., not chemically mixed with the other components). VR 14 may be commercially available as unvulcanized uncured rubber compound, in sheets approximately one half inch thick (although any size may be usable), strips, or pellets.

The TPR 15, which may be used in lieu of VR14 in an alternate embodiment, may be defined as a thermoplastic rubber compound that does not harden and stabilize by vulcanization but rather by being cooled after being subjected to elevated temperatures in the compression mold 40 process. The TPR 15 may include over 75% styrene-butadiene or ethylene-propylene, and small amounts of hardeners, such as EVA (ethylene vinyl acetate), PE (polyethylene), or PP (polypropylene), and ultraviolet protectants and colorants. TPR 15 may be purchased commercially in granulated or powdered form, as: Santoprene, a registered trademark of Advanced Elastomer Systems, Akron, Ohio; Kraton, a registered trademark of Kraton Polymers US LLC, Houston, Tex.; and, Surlyn, a registered trademark of the Dupont Company. Its properties may generally be in the range of 40 to 90 Shore A hardness with a tensile strength of 1000 to 2300 psi.

VR 14, or TPR 15 in the alternate embodiment, may comprise the principal ingredient of each batch 26 in that upon vulcanization (or cooling as in the case of TPR 15), during the curing phase described below, it acts as the means for binding, bonding or crosslinking RCR 12 particles together forming a homogeneous substance having the requisite strength and physical attributes. Thus VR 14, or TPR 15, acts as the “binding element” for RCR12. Utilization of VR 14, or TPR 15, in this fashion is a significant departure from prior art methods for making structural elements from discarded/recycled rubber products.

For example, PCT/Hansen teaches that the two types of RCR adhere to each other by virtue of the milling operation and the application of heat. In addition, small amounts of polymers may be used to achieve the desired adhesive consistency of the two types of recycled crumb rubber as well as for strength enhancement. The polymer is said to operate as an extra adhesive (supplementing the adhesiveness of the two types of RCR) acting on the exterior surfaces of the RCR 12 particles in a fashion similar to gluing wood strips together. For that reason, in the prior art, a very small particle size is critical to enable a stronger bond due to each particle having a larger surface area.

Batch 26 may comprise VR 14 in a most preferred amount of 25% of total batch weight, while a preferred range may be 20% to 40%, and a useful range may be 15% to 60%.

In the alternate embodiment, batch 26 may comprise TPR 15 in a most preferred amount of 10% of total batch weight, while a preferred range may be 7% to 15%, and a useful range may be 4% to 25%.

Each batch 26 may also include hardener 16 to act on VR 14, or TPR 15, (together with the sulfur already contained as part of VR 14 or hardeners already contained as part of TPR 15) during the vulcanizing stage or cooling stage to increase hardness, stiffness, and flexural and compressive strength. Hardener 16 may comprise commercially available hardening agents, such as sulfur powder, clay powder, calcium carbonate, MBTS (mercapto benz thiazole disulfide), TBBS (tri-butyl benz-thiazole sulfenamide), TMTD (tetra methyl thiuram disulfide) or reactive resin hardeners (such as bakelite and phenol-formaldehyde analogs).

Use of hardener may improve both the physical binding and the chemical bonding achieved by VR14, or TPR 15, on the RCR 12 particles. Batch 26 may comprise hardener 16 in a most preferred range of 0.8% to 1.2% of total batch weight, while a preferred range may be 0.5% to 1.5%, and a useful range may be 0.1% to 4%.

The three materials, RCR 12, VR 14 or alternately TPR 15, and hardener 16 comprising batch 26 may be mixed within extruder 28, as part of extrusion method 11, further described below. A commercially available twin screw, mixing version, extruder 28 (such as Davis Standard NRM 12 inch Hot Feed Extruder) may provide a highly efficient mixing operation, although most common, commercially available, extruders 28 may be used effectively. As noted previously, in contrast to prior art methods for making structural elements from recycled rubber, the blended materials need not be milled prior to extrusion.

In another embodiment, the three materials, RCR 12, VR 14 or alternately TPR 15, and hardener 16 comprising batch 26 may be mixed within an injection molding machine 29. A commercially available injection molding machine 29 (such as Rep., Inc. Model H48 200 ton) may provide a highly efficient mixing operation. As previously noted, in contrast to prior art methods, the blended materials need not be milled prior to injection molding.

Still referring to FIG. 2, extruder 28 or injection mold 29 may then be employed to extrude or inject, through extrusion or injection nozzles (not shown) and into compression mold 40, material of a sufficient quantity to make the elastomeric structural element 30 being produced (as further described below). A mold release agent, such as a water soluble silicone, may be sprayed on the internal surfaces of compression mold 40 prior to introduction of materials to be molded to assure problem free release of completed elastomeric structural elements 30. Compression mold 40 may be sized and geometrically shaped to correspond to the desired finished product. However, since the molded materials, RCR 12, VR 14 or alternately TPR 15, and hardener 16, may be expected to shrink after the molding process, the actual size of the mold may incorporate dimensions that account for the shrinkage. Thus, the finished elastomeric structural element 30 may have the requisite finished dimensions after removal from compression mold 40 and after the step of being cooled 42 for a period of up to 48 hours without exposure to freezing temperatures.

While in compression mold 40, elastomeric structural element 30 may be subjected to application of a simultaneously applied heat/pressure step 25 having a more preferred range of ¼ to 1 hour, 250 to 300° F. (121 to 149° C.), and 500 to 800 psi (4137-6619 Kpa). A preferred range for the heat/pressure step 25 may be 10 minutes to 1½ hours, 220 to 350° F. (104 to 177° C.), and 400 to 1000 psi (2758-6895 KPa), while the useful ranges may be 5 minutes to 8 hours, 150 to 500° F. (66 to 260° C.), and 100-3000 psi (689-20684 KPa). Although the heat/pressure step 25 may be applied in compression mold 40, a standard autoclave molding rectangular tube, belt cure, injection mold or similar device may be utilized for that function. Elastomeric structural element 30 may then be cooled 42 to ambient temperature for a period of between 24 and 48 hours, without permitting exposure to temperatures at or below 32F° (0C°).

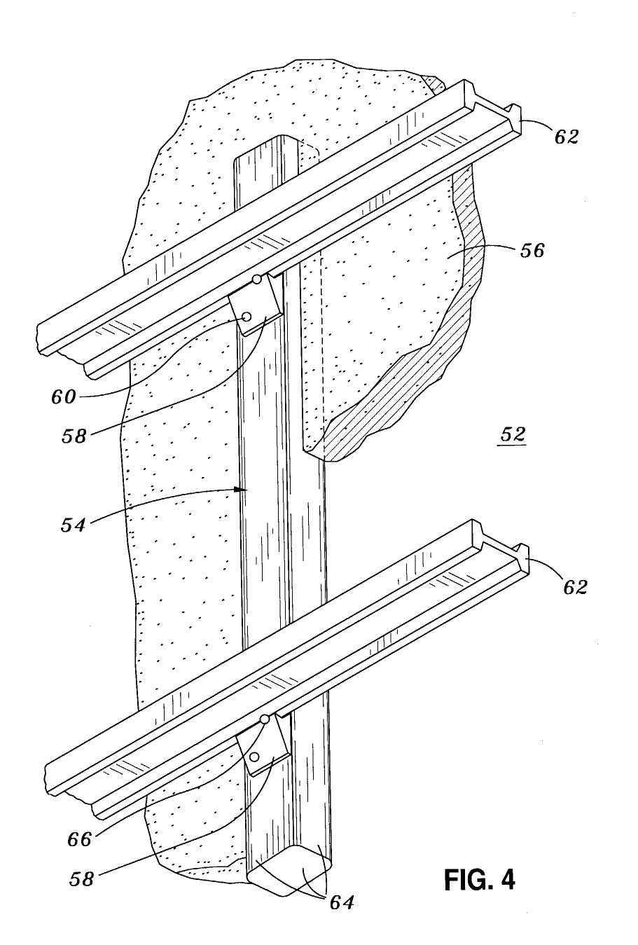

Completed elastomeric structural element 30 may then be subjected to a quality assurance step 32 involving both geometric and physical measurements and tests to determine its adequacy for its intended structural use. If destructive tests are necessary, they may be accomplished on a test article (not shown) made from the same batch, or a sample obtained from material that may be excess after cutting or trimming elastomeric structural elements 30 to final size. By way of example, if the elastomeric structural element 30 is intended for use as a railroad crosstie, it may be desired that it withstand a 370,000 lbs. (167,832 kg.) compression load upon an area equivalent to a standard railroad tie plate (see FIG. 4) of approximately 96 in² (619 cm²) with a temporary depressive deformation of ¼ in. (6.4 mm).

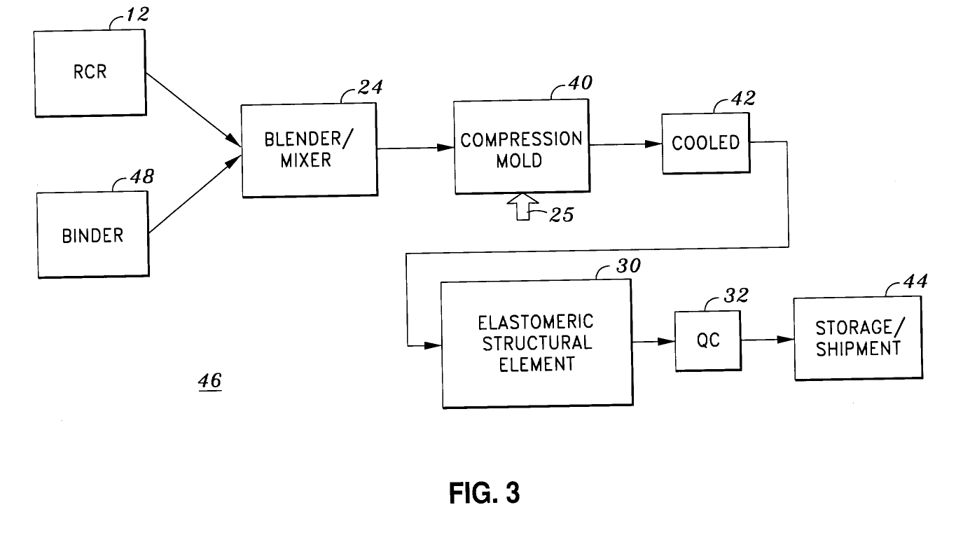

Referring now to FIG. 3, there is shown a flow diagram of a compression mold method 46 for fabricating elastomeric structural elements 30, such as railroad crossties, posts, substitutes for construction lumber, and other similar applications, according to another embodiment of the present invention. The compression mold 46 method may involve mixing the components RCR 12 and binder 48 to form a batch 26.

As in extrusion method 11 described above, RCR 12 may be obtained from any source (e.g., recycled tires or recycled rubber from other sources), and it is not necessary to stock two separate, distinct, and individually controlled recycled crumb rubbers, namely natural/de-vulcanized rubber and vulcanized crumb rubber. However, unlike the extrusion method, it may not be acceptable to use crumb rubber that has been shredded and granulated cryogenically (with the rubber in a frozen state) since that process may leave a glossy surface on the rubber particles, and that condition may detrimentally effect bonding characteristics. Additionally, it may be detrimental to utilize crumb rubber obtained from extremely old tires, such as those that might display extensive cracking and other such deterioration.

RCR 12 may be granulated to a most preferred particle size of 5/64 inch (2 mm), although it may be acceptable to have a preferred size range of from 3/32 to 1/16 inch (2.4 to 1.6 mm) and a useful size range of from 9/64 to 1/20 inch (3.6 to 1.3 mm). The size control may be either “pure” size or “minus” size. As discussed above, the latter industry designation allows inclusion of limited quantities (less than 5%) of particles having a smaller particle size, an acceptable condition for this inventive concept. However, sizeable quantities (over 15%) of very small particles (less than 1/20 inch) may be undesirable as that may increase void content as well as increase the amount necessary of binder 48. Use of a large RCR 12 particle size may also provide some collateral benefits in that the larger sizes may be more economical to produce (e.g. below 1/20 inch requires very expensive additional cracker mills), may be more readily available, and may be easier to handle.

Each batch 26 may comprise RCR 12 in a most preferred value of 94% of total batch weight, while a preferred range may be 92% to 95%, and a useful range may be 90% to 96%.

Binder 48 may comprise one or more of the following commercially available polyurethane based binders: Marchem 3800 series, Ryvec 400 series, or Diversified's P/U binder.

Binder 48 may act as the adhesive that firmly secures and binds RCR 12 particles to each other, thereby providing a homogeneous material characterized as having the mechanical properties delineated below. It may be vital that when tested by itself in a solidified state, the binder 48 utilized may have a hardness durometer Shore A rating of between 75 and 95, 90 being preferred. Each batch 26 may comprise binder 48 in a more preferred amount equivalent to 6% by overall weight. A preferred range may be 4.5% to 10% while a useful range may be 3% to 20%.

The two materials, RCR 12 and binder 48 may be mixed in blender/mixer 24, which may comprise a batch process Banbury mixer, ribbon mixer, mixing vat, mixer extruder, drop extruder or other similar method. A spraying technique may be employed for mixing liquefied type binders 48 with RCR 12, although powdered type binders 48 may also be introduced in blender/mixer 24.

Batch 26 may then be placed in compression mold 40. A mold release agent, such as a water soluble silicone, may be sprayed on the internal surfaces of compression mold 40 prior to introduction of materials to be molded to assure problem free release of completed elastomeric structural elements 30. While in compression mold 40, elastomeric structural element 30 may be subjected to application of a simultaneously applied heat/pressure step 25 having a more preferred range of ¼ to 1 hour, 250 to 300° F. (121-149° C.), and 500 to 800 psi (4137-6619 Kpa). A preferred range for the heat/pressure step 25 may be 10 minutes to 1½ hours, 220 to 350° F. (104-177° C.), and 400 to 1000 psi (2758-6895 KPa), while the useful ranges may be 5 minutes to 8 hours, 150-500° F. (66-260° C.), and 100-3000 psi (689-20684 KPa). Although the heat/pressure step 25 may be applied in compression mold 40, a standard autoclave, molding rectangular tube, belt cure, injection mold or similar devices may be utilized for that function. Elastomeric structural elements 30 may then be cooled 42 gradually for a period of between 24 and 48 hours, without permitting exposure to temperatures at or below 32 F° (0 C).

Cured elastomeric structural elements 30 may then be subjected to quality assurance step 32 measurements and tests to determine its adequacy for its intended structural use. If destructive test are necessary, they may be accomplished on a test article (not shown) made from the same batch, or a sample obtained from material that may be excess after cutting or trimming elastomeric structural elements 30 to final size. The cooled 42 cycle and storage/shipment step 44 may be the same for the compression mold method 46 as for the extrusion method 11.

Air pollution is not a hazard during performance of any phase of either the extrusion method 11 or the compression mold method 46. The molding temperature for both methods is between 150-500° F. (66 to 260° C.), and at this temperature range, there are no significant amounts of toxic or hazardous gases escaping into the ambient environment. Additionally, RCR 12, VR 14, TPR 15, hardener 16, and binder 48 are not classified as hazardous materials.

Mechanical properties of elastomeric structural elements 30 made according to the present invention may be expected to meet or exceed standard specifications for structural applications, including railroad crossties. Those properties may include density, compressive strength, thermal expansion, rupture, elasticity, hardness, resistance to cracking, life expectancy, imperviousness to water intrusion, electrical resistivity, and capability to retain screws, bolts, nails, spikes, or other types of fasteners at pressures equal to or greater than conventional products.

In addition to the components comprising each batch 26 for both the extrusion method 11 and the compression mold method 46, the following components may be added or removed to realize material properties that may be desired for specific elastomeric structural element 30 applications:
a) Steel belts or beads from recycled tires may be removed from RCR 12 as part of the shredding and granulating process if it is necessary that the elastomeric structural element 30 meet specific electrical insulation requirements. An example of such an application may be railroad crossties, which may require use of non-conductive materials to preclude signal interruption.
b) Steel shreds, wire, or rods may be added to each batch 26 if the elastomeric structural element 30 application is subjected to tensile, bending or shear loads, as may be the case for building and highway products, such as beams, posts, columns, and lumber substitutes.
c) Calcium carbonate or clay in powder form, may be added if the elastomeric structural element 30 application requires hardness in excess of 85 Shore A.
d) Carbon black in powder form may be added if the elastomeric structural element 30 application requires resistance at 500 VDC in excess of 500 Megaohms.

Referring now to FIG. 4, there is shown a perspective view of an installed railroad crosstie 52 representing one application of an elastomeric structural element 30 made according to the common extrusion or compression mold method 10, the extrusion method 11 or the compression mold method 46 of the present invention As with standard railway installations, crosstie 54 is partially embedded in ballast material extending on either side of rails 62. Rails 62 are secured to crosstie 54 by means of tie plates 58 and spikes 60. An edge radius 64 may be provided along all corners and edges of crosstie 54 for avoidance of edge sloughing subsequent to molding and for appearance reasons.

Unlike prior art, railroad crossties 54 made from the inventive recycled materials do not need indentations on longitudinal sides to assure frictional engagement with gravel beds and to avoid slipping or sliding during positioning and alignment. The elastic properties of the crosstie 54 material are sufficient to retain its position on the bed, whether ballast, pavement, concrete dirt, or other suitable railway bed.

Crossties 54 may be installed side-by-side to wooden railroad crossties. This is in contrast to cement ties and other known alternative crossties where it is recommended that whole lines be replaced even though only some ties require replacement. Rails 62 may be secured to crossties 54 employing the standard tie plate 58 and spike 60 technique. However, other forms of securement, such as clips, bolts or screws may be used. Because crossties 54 may be compressed upon formation (by means of compression molds 40 described above), further compressive deformation following installation may be minimal. This may greatly reduce tie plate 58 cutting action, or the action of tie plates 58 sinking progressively lower into crossties 54 as more train weight passes overhead. The compression formed material may also enhance geometric or dimensional stability and permit true alignment of rails 62 during installation. Other crosstie products, including those made from softwoods and hardwoods, require allowances for compressive deformation over time.

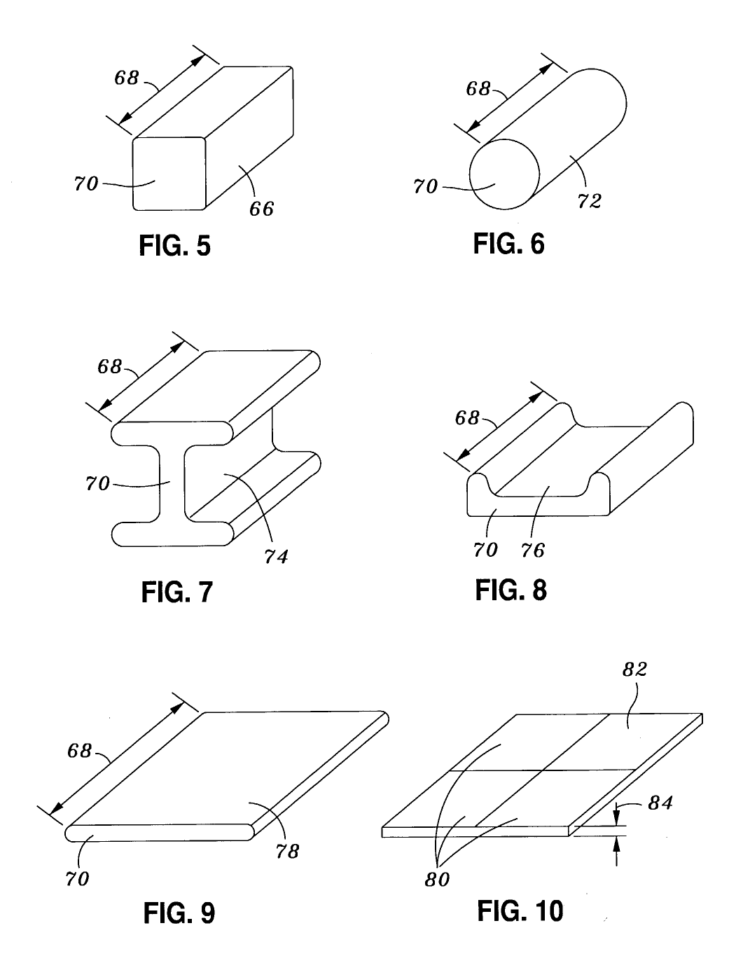

Referring now to FIGS. 5 through 9, there are shown perspective views of members having varying cross sectional shapes, representing other applications for elastomeric structural elements 30 made according to method 10 involving either the extrusion method 11 or the compression mold method 46 of the present invention. FIG. 5 illustrates a square shaped member 66, FIG. 6, a cylindrical-shaped member 72, FIG. 7, an I-beam shaped member 74, FIG. 8, a channel shaped member 76, and FIG. 9, a rectangular shaped member 78. The dimensions of cross sections 70 and lengths 68 may correspond to those necessary for the specific application of the various cross sections. By way of example, those applications may include, but are not necessarily limited to the following: structural member for buildings, bridges, towers, trestles, or other similar structures; fence post; rollers; rubber conveyor belt rub strips; highway guardrail components such as posts, blocks and spacers; speed bumps; weighted bases for traffic channelizing or signs; earth retention devices; columns; landscaping ties; landscaping steps; railroad rail tie plate pads (for noise and vibration attenuation and/or spacing); substitutes for bridge timbers; crane and heavy machinery runway track supports; substitutes for construction lumber; and, substitutes for deck lumber.

Referring now to FIG. 10, there is shown a perspective view of a plurality of tile shaped members 72 representing another application of an elastomeric structural element 30 made according to method 10 involving either the extrusion method 11 or the compression mold method 46 of the present invention. The surface dimensions 82 and thickness 84 of each tile shaped member 80 may correspond to those necessary for the specific application. By way of example, those applications may include, but are not necessarily limited to the following: floor tile; roof tile; projectile or shrapnel retention or attenuation tile; and sound absorbing tiles.

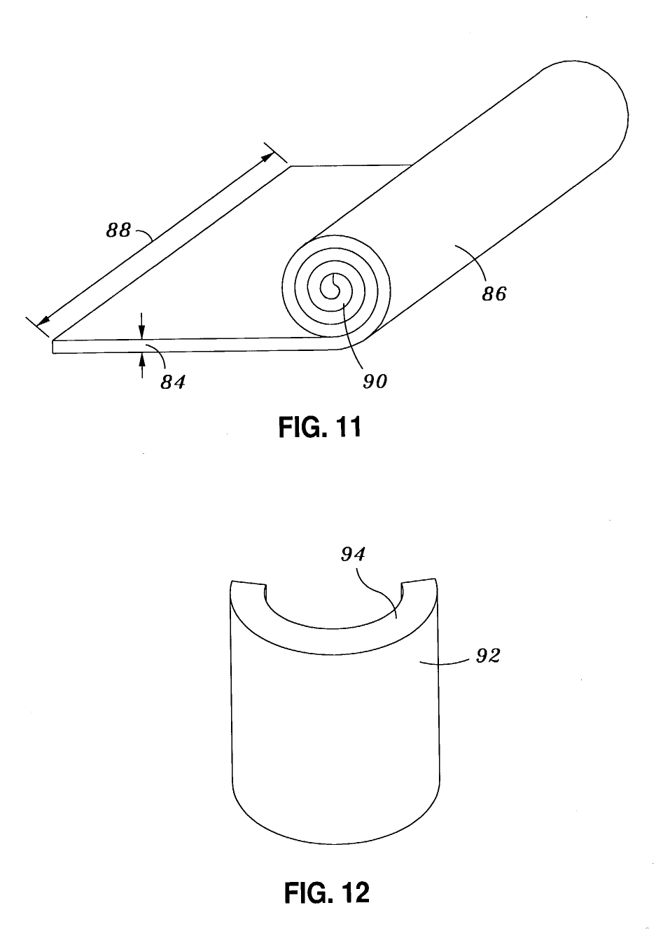

Referring now to FIG. 11, there is shown a perspective view of a mat shaped member 86 representing another application of an elastomeric structural element 30 made according to method 10 involving either the extrusion method 11 or the compression mold method 46 of the present invention. The mat shaped member is shown rolled for illustration purposes only, as it may be stored in any convenient manner. The thickness 84, width 88, and rolled length 90 may correspond to those necessary for the specific application. By way of example, those applications may include, but are not necessarily limited to the following: ballast mat; roadway crossing mat; livestock floor mat; construction mat; water sealing mat; and sound absorbing mat.

Referring now to FIG. 12, there is shown a perspective view of a bumper shaped member 92 representing another application of an elastomeric structural element 30 made according to method 10 involving either the extrusion method 11 or the compression mold method 46 of the present invention. The dimensions and cross section 94 of each bumper shaped member 92 may correspond to those necessary for the specific application. By way of example, those applications may include, but are not necessarily limited to the following: dock bumper; truck bumper; loading dock bumper; construction spacers; and tugboat or barge bumpers.

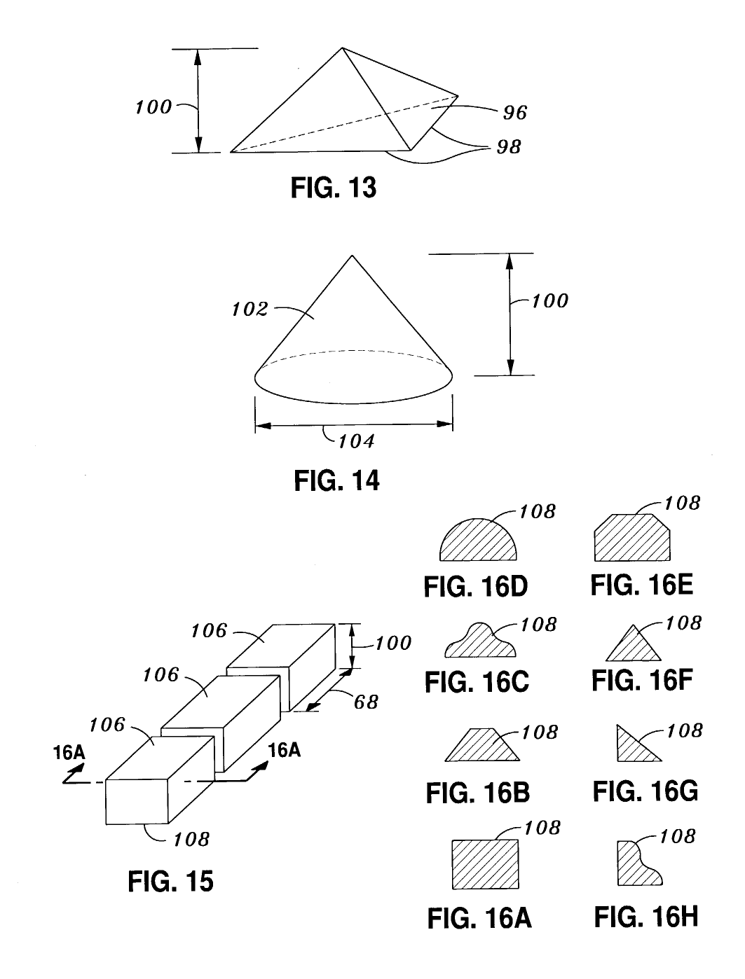

Referring now to FIG. 13, there is shown a perspective view of a pyramid shaped member 96 representing another application of an elastomeric structural element 30 made according to method 10 involving either the extrusion method 11 or the compression mold method 46 of the present invention. The pyramid-shaped member may be three sided, as shown of FIG. 13, or four sided (not shown), and may have a square or rectangular shaped base. The base dimension 98 and height 100 of each pyramid-shaped member 96 may correspond to those necessary for the specific application. By way of example, those applications may include, but are not necessarily limited to the following: curb bumper, parking stop, spacer, channel wall, and traffic lane divider. These elements may be linked together or concatenated by interlocking ball and sockets or similar well known attachment mechanisms.

Referring now to FIG. 14, there is shown a perspective view of a cone-shaped member 102 representing another application of an elastomeric structural element 30 made according to method 10 involving either the extrusion method 11 or the compression mold method 46 of the present invention. The height 100 and diameter 104 of each pyramid-shaped member 104 may correspond to those necessary for the specific application. By way of example, those applications may include, but are not necessarily limited to the following: spacer, traffic delineator, flexible sub-bed for construction, standoff, and shock attenuator to prevent shipment damage.

Referring now to FIG. 15, there is shown a perspective view of a series of linearly aligned interconnected curbing-shaped members 106 representing another application of elastomeric structural elements 30 made according to method 10 involving either the extrusion method 11 or the compression mold method 46 of the present invention. FIG. 16 shows several alternate cross sectional views taken along lines 16-16 of FIG. 15. Views A through H illustrate various alternate embodiments for the cross section of curbing-shaped members 106. Included may be rectangular, square, triangular, domed, polyhedron, pyramidal, and variations thereof such as a sphere and hemisphere (not shown). Depending on the specific application, curbing-shaped members 106 may be installed such that the base 108 is parallel to the ground, or alternately at any angle to the ground, such as perpendicular as needed for a wall installation. The length 68, height 100, and cross sectional configuration and dimensions of curbing-shaped members 106 may correspond to those necessary for the specific application. By way of example, those applications may include, but are not necessarily limited to the following: traffic curb, lane divider, traffic sign support base, post base, wheel chock, molding, boat and dock bumper, speed bump, parking stop, spacer, curbing, tie spike inserts, tie plugs, spike seat, end-of-track abutment, rail spacer and separator. Any number of curbing-shaped members 106 may be interconnected or concatenated by interlocking ball and socket or similar attachment mechanisms that may permit linear (as illustrated in FIG. 15) as well as non-linear alignment of assemblies, the latter allowing for curves and arcs.

It should be understood, of course, that the foregoing relates to preferred embodiments of the invention and that modifications made be made without departing from the spirit and scope of the invention as set forth in the following claims.

1. A method for fabricating elastomeric structural elements, comprising the steps of:
blending recycled crumb rubber and a binder;
curing said blended recycled crumb rubber and binder, without first milling, in a heated and pressurized compression mold to form said elastomeric structural elements;
cooling to ambient temperature said cured elastomeric structural elements.

2. The method of claim 1, wherein electrically conductive material has been removed from said recycled crumb rubber.

3. The method of claim 1, wherein electrically conductive material has been added to said recycled crumb rubber.

4. The method of claim 1, wherein said binder comprises one of an uncured vulcanizable rubber compound, an unset thermoplastic rubber compound, and a polyurethane based compound.

5. A method for fabricating elastomeric structural elements, comprising the steps of:
blending materials comprising recycled crumb rubber of only a single type, a binder comprising an uncured vulcanizable rubber compound, and a hardener;
placing said materials, without first milling, in an extruder;
extruding onto a heated compression mold, said materials; and
removing from said compression mold cured elastomeric structural elements, and allowing said cured elastomeric structural elements to cool to ambient temperature.

6. The method of claim 5, wherein said blended materials comprise 40 to 80% by batch weight of said recycled crumb rubber having a particle size no larger than in the range of 9/64 to 1/20 inch (3.6 to 1.3 mm); 20 to 60% by batch weight of said uncured vulcanizable rubber compound; and, 0.1 to 2% by batch weight of said hardener.

7. The method of claim 5, further comprising the step of compressing and heating said cured elastomeric structural elements in said compression mold within the ranges of: 250 to 1250 psi (1724 to 8618 kPa) pressure at a temperature of 210 to 350° F. (99 to 177° C.) for a period of 10 minutes to 8 hours.

8. The method of claim 5, further comprising the step of blending said materials, wherein said hardener comprises one of hardening agents of sulfur powder, clay powder, calcium carbonate, MBTS (mercapto benz thiazole disulfide), TBBS (tri-butyl benz-thiazole sulfenamide), TMTD (tetra methyl thiuram disulfide), and reactive resin.

9. The method of claim 5, wherein said blended materials comprise recycled crumb rubber, a binder comprising an unset thermoplastic rubber compound, and a hardener;

10. The method of claim 5, wherein said blended materials comprising 40 to 80% by batch weight of said recycled crumb rubber having a particle size no larger than in the range of 9/64 to 1/20 inch (3.6 to 1.3 mm); 4 to 25% by batch weight of said unset thermoplastic rubber compound; and 0.1 to 2% by batch weight of said hardener.

11. The method of claim 5, further comprising the step of placing said materials, without first milling, in an injection molding machine.

12. A method for fabricating elastomeric structural elements, comprising the steps of:
blending materials comprising: 40 to 80% by batch weight of recycled crumb rubber of only a single type, and containing a blend no larger than in the range of 9/64 to 1/20 inch (3.6 to 1.3 mm); 20 to 60% by batch weight of a binder comprising an uncured vulcanizable rubber compound; and 0.1 to 2% by batch weight of a hardener;
placing said materials, without first milling, in an extruder;
extruding onto a compression mold said materials;
compressing and heating said materials, while in said compression mold, to a pressure of 250 to 1250 psi (1724 to 8618 kPa) at a temperature of 210 to 350° F. (99 to 177° C.) for a period of 10 minutes to 8 hours;
removing said cured elastomeric structural elements from said compression mold; and
allowing said cured elastomeric structural elements to cool to ambient temperature.

13. The method of claim 12, wherein electrically conductive material has been removed from said blended materials.

14. The method of claim 12, wherein electrically conductive material has been added to said blended materials.

15. The method of claim 12, wherein said hardener material comprises one of hardening agents, of sulfur powder, clay powder, calcium carbonate, MBTS (mercapto benz thiazole disulfide), TBBS (tri-butyl benz-thiazole sulfenamide), TMTD (tetra methyl thiuram disulfide), and reactive resin.

16. The method of claim 12, wherein blending of said materials is done in a continuous-flow mixer.

17. The method of claim 12, wherein blending of said materials is done in a batch-type mixer.

18. The method of claim 12, wherein blending said materials is done in said extruder.

19. The method of claim 12, further comprising the step of compressing and heating said elastomeric structural elements in an autoclave.

20. A method for fabricating elastomeric structural elements, comprising the steps of:
blending materials comprising recycled crumb rubber of only a single type and a binder;
placing said materials, without first milling, in a compression mold; curing said blended materials in said compression mold by application of heat and pressure, to form said elastomeric structural elements;
removing from said compression mold said cured elastomeric structural elements, and
allowing said cured elastomeric structural elements to cool to ambient temperature.

21. The method of claim 20, wherein said materials comprise: 90 to 97% by batch weight of said recycled crumb rubber having a particle size no larger than in the range of 9/64 to 1/20 inch (3.6 to 1.3 mm); and 3 to 10% by batch weight of said binder.

22. The method of claim 20, wherein said elastomeric structural element is heated and compressed in said compression mold within the ranges of: 250 to 1250 psi (1724 to 8618 kPa) pressure at a temperature of 210 to 350° F. (99 to 177° C.) for a period of 10 minutes to 8 hours.

23. The method of claim 20, wherein said binder material comprises a polyurethane based compound having a hardness durometer Shore A rating of 75 to 95 when in a solidified state.

24. A method for fabricating elastomeric structural elements, comprising the steps of:
blending materials comprising 90 to 97% by batch weight of recycled crumb rubber of only a single type having a particle size no larger than in the range of 9/64 to 1/20 inch (3.6 to 1.3 mm), and 3 to 10% by batch weight of a binder;
placing said materials, without first milling, in a compression mold; curing said blended materials in said compression mold by application of heat and pressure, to form said elastomeric structural elements;
removing from said compression mold said cured elastomeric structural elements, and
allowing said cured elastomeric structural elements to cool to ambient temperature.

25. The method of claim 24, wherein electrically conductive material has been removed from said blended materials.

26. The method of claim 24, wherein electrically conductive material has been added to said blended materials.

27. The method of claim 24, wherein said binder material comprises a polyurethane compound having a hardness durometer Shore A rating of 75 to 95 when in a solidified state.

28. The method of claim 24, further comprising the step of blending said materials in a continuous-flow Banbury-type mixer.

29. The method of claim 24, further comprising the step of blending said materials in a batch mixer.

30. The method of claim 24, further comprising the step of blending said binder by spraying.

31. The method of claim 24, further comprising the step of compressing and heating said elastomeric structural elements in an autoclave.

32. An elastomeric structural element made with recycled rubber, comprising:
recycled crumb rubber of only a single type and a binder;
wherein said recycled crumb rubber and binder are heated and pressurized in a compression mold to form said elastomeric structural element;
wherein said cured elastomeric structural element is cooled to ambient temperature.

33. The elastomeric structural element of claim 32, wherein said elastomeric structural elements have a geometry and dimensions necessary for structural application use on any one of railroads, highways, and buildings.

34. An elastomeric structural element made with recycled rubber, comprising:
materials comprising: 40 to 80% by weight of recycled crumb rubber of only a single type, and containing a blend no larger than in the range of 9/64 to 1/20 inch (3.6 to 1.3 mm); 20 to 60% by weight of uncured vulcanizable rubber compound; and 0.1 to 2% by weight of a hardener;
wherein said materials are extruded onto a compression mold; wherein said materials are heated and pressurized in said compression mold to form said cured elastomeric structural element;
wherein said cured elastomeric structural element is cooled to ambient temperature.

35. The elastomeric structural element of claim 34, wherein said materials comprise: 40 to 80% by weight of recycled crumb rubber containing a blend no larger than in the range of 9/64 to 1/20 inch (3.6 to 1.3 mm); 4 to 25% by batch weight of said uncured thermoplastic rubber compound; and 0.1 to 2% by weight of a hardener;

36. The elastomeric structural element of claim 34, wherein said compression mold is configured to form structural elements having a geometry, cross section, and length necessary for use on any one of railroads, highways, and buildings.

37. The elastomeric structural element of claim 34, wherein said compression mold is geometrically configured to mold said elastomeric structural element having a length and any one of a square, rectangular, cylindrical, channel shaped, I-beam shaped, triangular, and elliptical cross section.

38. The elastomeric structural element of claim 34, wherein said compression mold is configured to mold elastomeric structural elements having a geometry of any one of a pyramid, cone, rectangle, square, triangle, dome, sphere, hemisphere, polyhedron, channel, I-beam, and ellipse.

39. The elastomeric structural element of claim 34, wherein said compression mold is geometrically configured to mold a railroad crosstie.

40. The elastomeric structural element of claim 34, wherein said compression mold is geometrically configured to mold any one of a railroad switch tie and a railroad switch tie set.

41. An elastomeric structural element made with recycled rubber, comprising:
materials comprising: 90 to 97% by weight of a portion of recycled crumb rubber of only a single type containing a blend no larger than in the range of 9/64 to 1/20 inch (3.6 to 1.3 mm), and 3 to 10% by weight of a binder
wherein said materials are blended and placed in a compression mold;
wherein said material are heated and pressurized said compression mold to form said cured elastomeric structural element;
wherein said cured elastomeric structural element is cooled to ambient temperature.

42. The elastomeric structural element of claim 41, wherein binder comprises a polyurethane-based compound having a hardness durometer Shore A rating of 75 to 95 when in a solidified state.

43. The elastomeric structural element of claim 41, wherein said compression mold is configured to form structural elements having a geometry, cross section, and length necessary for use on any one of railroads, highways, and buildings.

44. The elastomeric structural element of claim 41, wherein said compression mold is geometrically configured to mold said elastomeric structural element having a length and any one of a square, rectangular, circular, channel shaped, I-beam shaped, triangular, and elliptical cross section.

45. The elastomeric structural element of claim 41, wherein said compression mold is configured to mold elastomeric structural elements having a geometry of any one of a pyramid, cone, rectangle, square, triangle, dome, sphere, hemisphere, polyhedron, channel, I-beam, and ellipse.

46. The elastomeric structural element of claim 41, wherein said compression mold is geometrically configured to mold a railroad crosstie.

47. The elastomeric structural element of claim 41, wherein said compression mold is geometrically configured to mold any one of a railroad switch tie and a railroad switch tie set.
